(19) United States
(12) Patent Application Publication
(10) Pub. No.: US 2007/0097529 A1
(43) Pub. Date: May 3, 2007

(54) Apparatus for the thermal compensation of an optical system

(76) Inventors: Uwe Weber, Aalen (DE); Karl-Heinz Roesner, Essingen (DE); Hans-Joachim Weippert, Aalen (DE)

Correspondence Address: HARNESS, DICKEY & PIERCE, P.L.C., P.O. BOX 828, BLOOMFIELD HILLS, MI, 48303, US

(21) Appl. No.: 11/542,771

(22) Filed: Oct. 4, 2006

(30) Foreign Application Priority Data
Oct. 4, 2005 (DE) 10 2005 048 085.3
Sep. 21, 2006 (DE) 10 2006 046 416.8

(51) Int. Cl. G02B 7/02

(52) U.S. Cl. 359/820

(57) ABSTRACT

An apparatus for the thermal compensation of an optical system is disclosed. The apparatus comprises a housing, at least one optical element adapted to be displaced relative to the housing, and at least one piston-and-cylinder unit positioned directly between the housing and the optical element. The piston-and-cylinder unit acts on the position of the optical element within the housing. It contains a fluid. The coefficients of volumetric thermal expansion of the piston, the cylinder and the fluid are selected such that for a predetermined change in temperature of the apparatus a defined relative displacement between the piston and the cylinder takes place which compensates the change of the optical properties of the optical system caused by the change in temperature. The fluid is a polymer system.

### FIELD OF THE INVENTION

The present invention is related to the field of optical systems.

More specifically, the invention is related to the filed of thermal compensation of an optical system.

Still more specifically, the invention is related to an apparatus for the thermal compensation of an optical system, comprising a housing, at least one optical element adapted to be displaced relative to the housing, and at least one piston-and-cylinder unit positioned directly between the housing and the optical element, the piston-and-cylinder unit acting on the position of the optical element within the housing and containing a fluid, wherein the coefficients of volumetric thermal expansion of the piston, the cylinder and the fluid are selected such that for a predetermined change in temperature of the apparatus a defined relative displacement between the piston and the cylinder takes place which compensates the change of the optical properties of the optical system caused by the change in temperature.

### BACKGROUND OF THE INVENTION

Optical systems are temperature sensitive. Under the influence of temperature the geometry of lenses (radii, thickness, diameter) changes as well as the refractive index of the lens material used. The surrounding structure (the mounts and the barrel supporting the optical elements) change likewise. These changes effect a deterioration of the imaging quality.

In this context various approaches have become known for compensating this negative influence of changes in ambient temperature.

A first approach consists in purposefully combining materials for the components of the optical system with different coefficient of volumetric thermal expansion, such that the different volumetric thermal expansions just compensate one another. This approach, however, has substantial effects on the design of the components. It is, moreover, quite limited in its efficiency because the thermal coefficients of solids only differ little, and, therefore, the components have to be quite voluminous for obtaining noticeable compensation effects. Further, the selection of materials becomes limited thereby.

A second approach works with actuators which purposefully change the position of one or several optical elements within the system during a change in temperature, such that the imaging errors caused by the temperature change are compensated.

In this context one has already used apparatuses in which a bi-metallic element changes its shape as a function of temperature and an actuating force is derived therefrom. The forces generated thereby are, however, quite small and allow only small amounts of displacement for the optical elements.

On the other hand one has also been working with temperature sensors for controlling an actuator, for example a motor in connection with a pinion-and-rack drive unit, a spindle drive unit, a piezo drive unit or the like. By doing so one may obtain high actuating forces and long distances of displacement, however, one has to put up with the fact that the dimensions of the units require substantial space. Moreover, such systems require an electrical power supply which is not available for many optical systems, for example telescopes, and which is not desired either.

Finally, apparatuses have become known utilizing a piston-and-cylinder unit in which one takes advantage of the substantial difference in thermal coefficients between solids on the one hand and liquids on the other hand.

Document EP 1 081 522 B1 discloses a temperature-compensated objective lens for a film camera. In this objective lens the optical components are not displaced. Only the index ring is rotated relative to the rotatable distance setting ring for compensating the scale values on the distance setting ring which would be faulty otherwise. The actuator used for that purpose comprises a wax motor with a cylinder and a piston moving temperature-dependent with the coefficient of volumetric thermal expansion of the wax, and thereby rotates the ring. The wax motor rotates the ring in dependence of the temperature acting on it which expands or contracts, respectively, a liquid contained therein. The ring is biased in a circumferential direction by a compression spring, thereby overpowering by pressure any play that might exist.

This prior art apparatus has the disadvantage that the adjustment of the optical elements required for focusing is effected indirectly because the wax motor acts on the adjustment ring, and, therefore, also influences its reading.

Document U.S. Pat. No. 4,525,745 A discloses a similar apparatus for the thermal compensation of a focusing unit in a projection objective lens. The apparatus comprises a piston-and-cylinder unit with a cylinder and a piston that is likewise biased by springs. Her, too, the optical elements are adjusted indirectly, namely by means of a lever or a cam drive.

Document U.S. Pat. No. 3,162,664 A discloses still another such apparatus having likewise a spring-biased piston and an indirect adjustment via coupling elements.

Document U.S. Pat. No. 4,919,519 A discloses a fluid thermal compensation system for an objective lens. This system provides for a piston-and-cylinder unit directly between the housing and a lens of the objective lens. A liquid, namely a mixture of 66% ethylene glycol (with inhibitors) and 34% water is contained in the piston-and-cylinder unit cavity. This liquid is selected because of its low freezing point of −65° C. The liquid has a coefficient of volumetric thermal expansion of 540×10⁻⁶/°C.

In such systems liquids have substantial drawbacks. These draw-backs of liquids in particular consist in that already a small loss of liquid results in the formation of little gas bubbles so that the thermal compensation system becomes inoperable as a whole, and, on the other hand, the leaking liquid contaminates optical surfaces.

### SUMMARY OF THE INVENTION

It is, therefore, an object underlying the invention to improve an apparatus of the type specified at the outset, such that the afore-mentioned drawbacks are avoided. In particular, an apparatus shall be provided that has a reliable thermal compensation over long time use, and which is simple to manufacture.

In an apparatus of the type specified at the outset this object is achieved in that the fluid is a polymer system.

The object underlying the invention is, thus, entirely solved.

The use of a polymer system instead of a liquid namely has the advantage that due to the higher viscosity, as compared to that of prior art hydraulic fluids, fluid will practically not escape in case of a leakage, such that one has not to be afraid of either an impairment to the thermal compensation system due to the formation of gas bubbles, or a contamination of the optical elements.

In particularly preferred embodiments of the invention the polymer system is a reactive polymer system being liquid in the non-cured state, and having a consistency between that of a gel and that of an elastomer in the cured state.

This measure has the advantage that during the manufacture of the optical system the polymer system, due to its low viscosity in the non-cured state, may be filled into the thermal compensation system in a simple manner, and that after curing it assumes the desired higher viscosity in situ.

It is, further, preferred when the polymer system is selected from the group consisting of: silicones, polyurethanes, acrylates, epoxies, urethaneacrylates, epoxyacrylates, polysulfides, hot-melt adhesives, hot-melt resins, ketone resins, colophonium derivates, waxes.

These substances, the enumeration of which being not to be understood as a limitation, have turned out to be particularly appropriate during practical tests.

In embodiments of the invention the polymer system is an addition crosslinking two-component casting compound.

This measure has the advantage that during the manufacture of the optical system the polymer system may be produced in a simple manner by mixing the two components with each other.

According to the invention, a particularly good effect is achieved in that fillers are admixed to the polymer system.

This measure has the advantage that the properties of the polymer system may be purposefully adjusted.

Preferred as fillers are nano particles, in particular SiO₂ particles having a particle size of between 5 and 20 nm, preferably of 10 nm.

The preferred optical elements are lenses or groups of lenses. The invention, however, may likewise be used in connection with other optical elements, for example aperture stops or mirrors.

The optical system, preferably, is an objective lens, for example for a camera or a telescope.

In embodiments of the invention the piston and the cylinder are each configured sleeve-shaped and coaxial to the optical element.

This measure has the advantage that a particularly compact design is obtained which, as compared to conventional apparatuses without thermal compensation requires only a very small additional space.

In this context it is particularly preferred when the piston and the cylinder surround the optical element.

In the context of the present invention the kinetic alternative is preferred in which the optical element is connected to the cylinder and the housing is connected to the piston.

In a further group of embodiments the piston is biased relative to the cylinder by means of a spring.

This measure has the advantage that a remaining play, likewise a play caused by the required gaskets within the piston-and-cylinder unit is suppressed.

Another embodiment of the invention is characterized in that the piston-and-cylinder unit comprises a cavity for the fluid, and that the cavity is subdivided into a plurality of axial chambers in a circumferential direction.

This measure has the advantage that in the case of unfavorable length conditions one avoids that the piston tilts within the cylinder because the fluid expands homogenously within the chambers.

Moreover, a measure is preferred, according to which the piston-and-cylinder unit comprises a cavity for the fluid, and the cavity is connected to an auxiliary cavity.

This measure has the advantage that the expanding fluid volume may be positioned at an arbitrary location within the optical system. This results in additional design options, and, due to a larger volume, larger expansions to be exploited.

Further advantages will become apparent from the description and the enclosed drawings.

It goes without saying that the features mentioned before and those that will be explained hereinafter may not only be used in the particularly given combination but also in other combinations, or alone, without leaving the scope of the present invention.

### BRIEF DESCRIPTION OF THE DRAWINGS

Embodiments of the invention are shown in the drawing and will be explained in further detail throughout the subsequent description.

FIG. 1 is a schematic depiction of a piston-and-cylinder unit for explaining the invention; and

FIG. 2 is a partial, cross-sectional view, of an embodiment of the apparatus according to the invention, exemplified with respect to an objective lens.

### DETAILED DESCRIPTION OF THE PREFERRED EMBODIMENTS

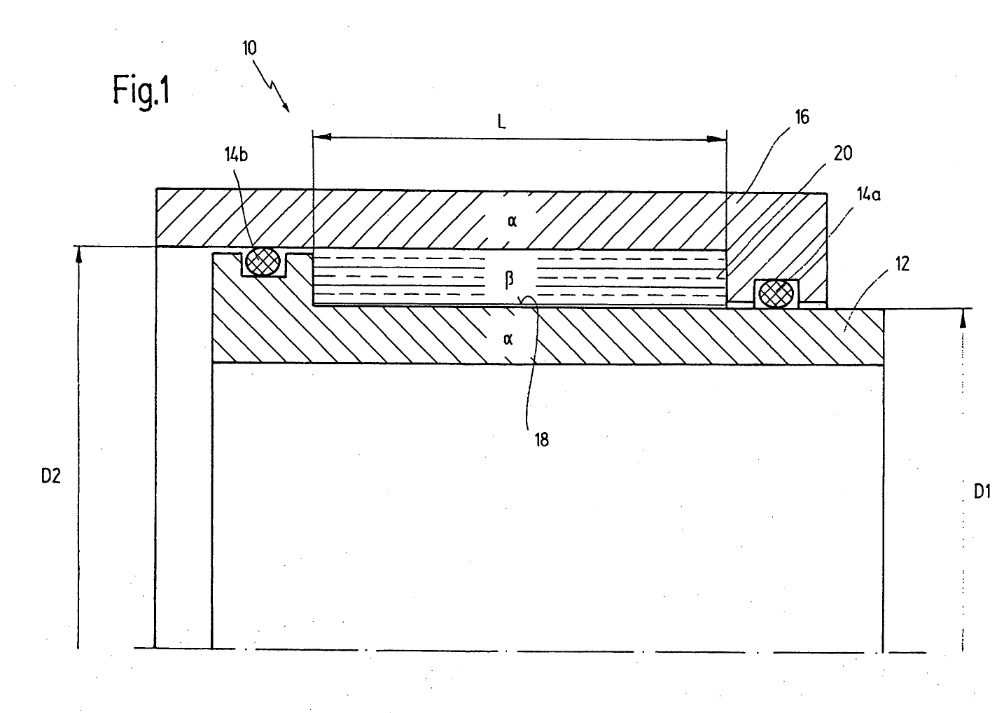

In FIG. 1 reference numeral 10 as a whole designates a hydraulic adjustment unit. Adjustment unit 10 comprises a sleeve-shaped piston 12 which slides within a likewise sleeve-shaped cylinder 16 via gaskets or seals 14a, 14b. With corresponding annular shoulders piston 12 and cylinder 14 define an annular cavity 18 containing a fluid 20. According to the invention, fluid 20 is a polymer system.

Preferably, the polymer system is selected from the group consisting of: silicones, polyurethanes, acrylates, epoxies, urethaneacrylates, epoxyacrylates, polysulfides, hot-melt adhesives, hot-melt resins, ketone resins, colophonium derivates, waxes.

Further preferred is the use of 2K silicone rubber.

By using within the thermal compensation system a reactive polymer system having a consistence between that of a gel and that of an elastomer, the essential drawbacks of conventional hydraulic fluids are avoided. These drawbacks of liquids for example consist in that in view of sealing problems only highly fluorinated liquids may be used which in the long run behave indifferently in relation to the elastomers of the gaskets. A good sealing effect is essential in the present context because on the one hand already a small loss of liquid results in the formation of little gas bubbles so that the thermal compensation system becomes inoperable as a whole, and, on the other hand, the leaking liquid contaminates optical surfaces.

The polymer system used according to the invention, preferably, is an addition crosslinking two-component casting compound. This casting compound is filled into the thermal compensation system in its non-cured state which is highly facilitated by the low viscosity in that state. Only after the filling in the casting compound is crosslinked, for example with the help of heat or of ultraviolet light.

By properly selecting the casting compound and guiding the crosslinking process, the consistency of the cured polymer system may be set in wide ranges from gel-like over elastomer-like to brittle. For each individual application, the modulus of elasticity, the glass transition range, and the coefficient of volumetric thermal expansion are of importance.

The following coefficients of volumetric thermal expansion (each in 10⁻⁶/° C. units) have roughly been determined for the present application:

| | |
|---|---|
| Silicones: | 250-300 |
| Silicone gels: | 300-350 |
| Polyurethane: | 200-300 |
| Epoxy resin: | 60-80 |
| Polycarbonate (CR 39): | 100-120 |

wherein, as is well known, the coefficients of volumetric thermal expansion for aluminum are about 25, for steel are about 10-14, and for optical glass (BK 7) are about 7-8, also in 10⁻⁶/° C. units.

The properties of the polymer system may be purposefully modified by the admixing of fillers. Preferred as fillers are nano particles, for example SiO₂ particles having a particle size of between 5 to 20 nm, preferably of 10 nm.

Piston 12 and cylinder 14 consist of a solid material, in particular a metal. It is assumed that they both consist of the same material having a coefficient of volumetric thermal expansion designated α. The coefficient of volumetric thermal expansion of fluid 20 is designated β. In FIG. 1, further, the axial length of cavity 18 is designated as L, the outer diameter of piston 12 as D1 and the inner diameter of cylinder 16 as D2.

As the coefficient of volumetric thermal expansion β of fluid 20 is essentially higher as compared to the coefficient of volumetric thermal expansion α of piston 12 and cylinder 16, a change in temperature causes a relative axial movement between piston 12 and cylinder 16. In order to obtain a desired change in length ΔL for a predetermined temperature change ΔT, one has to calculate the required axial length L of cavity 18.

The volume V of cavity 18 is:
V=π/4(D2²−D1²)L [1]

The change in volume ΔV_{F} of fluid 20 (coefficient of volumetric thermal expansion β) for a change in temperature ΔT is:
ΔV_{F}=βΔTV=βΔTπ/4(D2²−D1²)L [2]

The change in volume ΔV_{H} of cavity 18 (coefficient of volumetric thermal expansion α) for a change in temperature ΔT is:
ΔV_{H}=(π/4(D2′²−D1′²)L′)−(π/4(D2²−D1²)L), [3]

wherein D‘′ and D2′ are the diameters of piston 12 and cylinder 16, and L′ is the length of cavity 18 at the temperature having changed by ΔT.

With
D1′=D1(1+αΔT) und D2′=D2(1+αΔT) [4]
and
L′=L+ΔL [5]

one obtains

$$\begin{matrix}Δ {V}_{H} = ( π / 4 ( {( 1 + α Δ T )}^{2} ( D {2}^{2} - D {1}^{2} ) ( L + Δ L ) - \\ ( D {2}^{2} - D {1}^{2} ) L ) = \\ = π / 4 ( D {2}^{2} - D {1}^{2} ) ( {( 1 + α Δ T )}^{2} ( L + Δ L ) - L ) = \\ = π / 4 ( D {2}^{2} - D {1}^{2} ) L ( {( 1 + α Δ T )}^{2} ( 1 + Δ L / L ) - 1 )\end{matrix} \qquad [ 6 ]$$

As the changes in volume ΔV_{F} and ΔV_{H} are equal, [3] and [6] may be equated, too, and one obtains for L:
L=ΔL/((βΔT+1)/(1+αΔT)²−1) [7]

For the design of FIG. 1 the diameters D1 und D2, and, hence, their tolerances, have no influence on the thermal compensation. The length L required for a change in length ΔL when temperature changes by ΔT solely depends on α and β.

Because the contribution from a is small, [7] may be simplified to read:
L=ΔL/(βΔT). [8]

Example: when piston 12 and cylinder 16 are made from aluminum (α=24×10⁻⁶/K) and fluid 20 is oil (β=10⁻³/K), then for a desired change in length ΔL=0.2 mm for a temperature change ΔT=20K the required length is obtained from equation [7] as L=10.54 mm, and from equation [8] as L=10 mm. The deviation of about 5% is acceptable, such that in practice one may calculate with simpler equation [8]. The example shows that length L for the desired change in length ΔL is very short, thus enabling a compact design.

FIG. 1 shows an apparatus with two O-ring seals 14a and 14b. Instead of these O-rings one may of course also use other kinds of slide seals or gaskets as are known in the field of hydraulics. Moreover, membrane seals, which do not slide, may likewise be used.

Irrespective of the kind of seal used, the problem of lost motion may arise which results in a hysteresis within the thermal compensation. The O-rings used are namely compressed in a radial direction for obtaining a sufficient sealing effect. Thereby, the elastic O-rings are broadened in an axial direction. For enabling such an axial broadening to happen, the groove housing the O-Ring must be axially broader as the O-Ring diameter. Accordingly, when the fluid becomes warmer or colder, respectively, the O-rings first move to the respective opposite groove wall before the piston and the cylinder start to move relatively to one another.

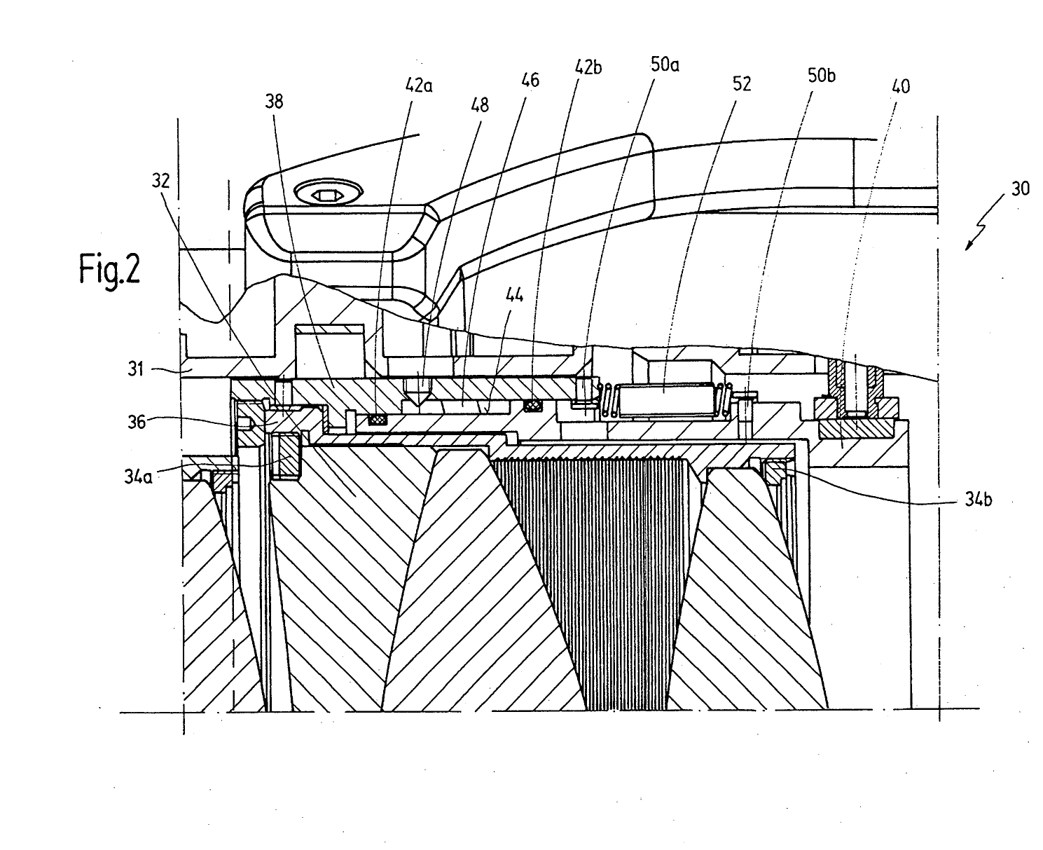

In the apparatus shown in FIG. 2, this disadvantage is avoided.

FIG. 2 shows an optical system 30, namely an objective lens. System 30 has a housing 31. An optical element 32, being a group of lenses in the embodiment shown, is housed axially displaceable within housing 31.

The lens group is held on opposite ends by means of holding rings 34a and 34b which are bolted to a sleeve 36 surrounding the lens group. Sleeve 36, in turn, is bolted to a sleeve-shaped cylinder 38 which is journalled axially displaceable within housing 31. A sleeve-shaped piston 40 is provided between sleeve 36 and cylinder 38. Piston 40 and cylinder 38, together with seals 42a and 42b surround a cavity 44. A fluid 46 is contained within cavity 44. Fluid 46 may be filled into cavity 44 via an opening which may be closed by a closure bolt 48. Piston 40 is bolted to housing 31.

Axial and circumferentially distributed pull springs 52 are provided between piston 40 and cylinder 38.

For the piston-and-cylinder unit 38, 49 the same holds true as already explained in connection with FIG. 1. The above discussed problem in connection with the lost motion caused by the seals is solved through the pull springs 52 because they bias piston 40, and, thereby, overpower the lost motion or the hysteresis, respectively, by compression.

In the case of a change of temperature, cylinder 38 together with the lens group move relative to piston 40 being rigidly connected to housing 31.

Starting from the system of FIG. 2, various advancements may be provided.

According to a first advancement one takes into account that under unfavorable length conditions, in particular for very short lengths of guide, cylinder 38 and piston 40 may tilt relative to one another. In order to avoid that, cavity 44 may be subdivided into several, preferably three or four axial chambers by providing several circumferentially distributed and radially meshing axial ridges. When fluid 46 gets warmer, it expands simultaneously and uniformly within all such chambers, thereby generating a parallel movement and, hence, an axial guide without the risk of tilting.

According to a second advancement an additional cavity is provided being connected to cavity 44. The additional cavity may be positioned at an arbitrary location within system 30. The larger volume, thus obtained results in a bigger expansion amount of the fluid, such that longer distances and/or higher forces of displacement may be obtained. The above calculation would, of course, have to be modified accordingly.

1. An apparatus for thermally compensating an optical system, comprising a housing, at least one optical element adapted to be displaced relative to said housing, and at least one piston-and-cylinder unit positioned directly between said housing and said optical element, said piston-and-cylinder unit acting on a position of said optical element within said housing and containing a fluid, wherein coefficients of volumetric thermal expansion of said piston, said cylinder and said fluid are selected such that for a predetermined change in temperature of said apparatus a defined relative displacement between said piston and said cylinder takes place which compensates a change of optical properties of said optical system caused by said change in temperature, wherein said fluid is a polymer system.

2. The apparatus of claim 1, wherein said polymer system is a reactive polymer system being liquid in the non-cured state, and having a consistency between that of a gel and that of an elastomer in a cured state.

3. The apparatus of claim 1, wherein said polymer system is selected from the group consisting of: silicones, polyurethanes, acrylates, epoxies, urethaneacrylates, epoxyacrylates, polysulfides, hot-melt adhesives, hot-melt resins, ketone resins, colophonium derivates, waxes.

4. The apparatus of claim 2, wherein said polymer system is an addition cross-linking two-component casting compound.

5. The apparatus of claim 1, wherein fillers are admixed to said polymer system.

6. The apparatus of claim 5, wherein said fillers are nano particles.

7. The apparatus of claim 6, wherein said nano particles are SiO₂ particles having a particle size of between 5 and 20 nm.

8. The apparatus of claim 7, wherein said nano particles have a particle size of 10 nm.

9. The apparatus of claim 1, wherein said optical element is a lens or a lens group.

10. The apparatus of claim 1, wherein said optical system is an objective lens.

11. The apparatus of claim 1, wherein said piston and said cylinder are each configured sleeve-shaped and coaxial to said optical element.

12. The apparatus of claim 11, wherein said piston and said cylinder surround said optical element.

13. The apparatus of claim 1, wherein said optical element is connected to said cylinder and said housing is connected to said piston.

14. The apparatus of claim 1, wherein said piston is biased relative to said cylinder by means of a spring.

15. The apparatus of claim 1, wherein said piston-and-cylinder unit comprises a cavity for said fluid, said cavity being subdivided into a plurality of axial chambers in a circumferential direction.

16. The apparatus of claim 1, wherein said piston-and-cylinder unit comprises a cavity for said fluid, said cavity being connected to an auxiliary cavity.
